(19) United States
(12) Patent Application Publication
(10) Pub. No.: US 2007/0132314 A1
(43) Pub. Date: Jun. 14, 2007

(54) Device and method for the disposal/disposal firing of occupant protection devices/road user protection devices with pyrotechnic igniters

(75) Inventors: Gunter Fendt, Schrobenhausen (DE); Lothar Weichenberger, Klingmoos (DE); Reinhard Helldorfer, Baiersdorf (DE); Thomas Gornig, Markt Indersdorf (DE)

Correspondence Address: Craig Hallacher;Continental Teves Inc, One Continental Drive, Auburn Hills, MI, 48326, US

(73) Assignee: Conti Temic Microelectronic GmbH

(21) Appl. No.: 10/588,599

(22) PCT Filed: Jan. 20, 2005
(86) PCT No.: PCT/DE05/00071

§ 371 Date: Aug. 7, 2006

(30) Foreign Application Priority Data
Feb. 6, 2004 (DE) 10 2004 006 032.0

(51) Int. Cl. B60L 1/00; F42C 21/00; B60R 21/16

(52) U.S. Cl. 307/10.1; 280/735; 102/206; 102/293

(57) ABSTRACT

Disclosed is a device and a method for disposal of occupant protection devices/road user protection devices with a pyrotechnic igniter, by which both a reliable disposal of the device as well as a stable/malfunction-free placing of the device in operation can be ensured with implemented disposal capabilities/disposal routines (protection from faulty activations in the event of simple errors).

### BACKGROUND OF THE INVENTION

The invention relates to a device and a method for disposal of occupant protection devices/road user protection devices with a pyrotechnic igniter. The method and the device are to be used advantageously especially with demounting or scrapping and scrap recycling of motor vehicles to be disposed of.

In particular, in motor vehicles occupant protection devices/road user protection devices with pyrotechnic igniters, for example airbags, belt tensioners, pedestrian protection & roll-over systems, have become accepted today due to their fast response time and their verifiable occupant protection effect/road user protection effect. The occupant protection devices/road user protection devices are fired by an activating order, which is produced by a control device subject to the acceleration forces acting onto the vehicle.

However, the issue, so far still largely unsettled, of disposal of motor vehicles with an occupant protection devices/road user protection devices of this type, is disadvantageous. Thus, it is unjustifiable for reasons of safety of work and fire protection to give vehicles with inactive pyrotechnic igniters and thus pyrotechnic active material into the circle of scrapping and scrap recycling.

Furthermore, the number of the occupant protection devices/road user protection devices built into a vehicle will continue to increase and will vary individually per vehicle according to the respective customer preference for equipment, so that also the clearness on the number and position of the pyrotechnic igniters can get lost and expanding them is to expensive and unreliable.

Divers solutions are already known for disposal of occupant protection devices with pyrotechnic igniters.

From DE 197 53 058 C2 for example a method is known for disposal of pyrotechnic igniters as well as a disposal device for implementing the method, which gives a disposal firing order to an igniter or to an intermediate control device and the igniter is fired/the igniters are fired.

From DE 101 13 099 A1 for example a method is known for disposal of airbags as well as a device for implementing the method, for which demounting of the airbag can be simplified by arranging a device in front of the airbag in its fitting position for collecting gases or solid bodies and by firing the airbag, the device being preferably embodied as a funnel with an exhaust equipment arranged thereto.

With these above-mentioned devices and methods for disposal of pyrotechnic igniters it is implicitly understood that the communication for transmitting the disposal order in case of need functions at any time faultlessly and malfunction-free, respectively, when it comes to communication errors. As in the software code corresponding routines must be implemented into the control device of the vehicle for the occupant protection devices/road user protection devices, so that a corresponding disposal order can be supplied to the control device from outside, this freedom from error comprises and extends, respectively, over the entire life time of the system, so that for example an erroneously faulty interpretation of a simple communication sequence with the control device, as this has to be effected in the garages for service purposes, does not cause or may cause an undesired faulty activation of all occupant protection devices/road user protection devices. Likewise it must be ensured that by a simple fault in the software operation of the control device in the vehicle for the occupant protection devices/road user protection devices, such as for example a so-called “code-run-away”, the software routines/software codes, implemented in the control device, for disposal cannot inadvertently be activated, or in case this shall happen, this does not result in the undesired effects in case of fault.

It is, therefore, the object of the invention to indicate/create a method for disposal as well as a device/a control device by means of which both a reliable disposal of the device as well as a stable/malfunction-free placing of the device in operation can be ensured with implemented disposal capabilities/disposal routines (protection from faulty activations in the event of simple errors).

### SUMMARY OF THE INVENTION

This object is achieved by a method for disposal of road user protection devices with at least one pyrotechnic igniter, in which a disposal firing order is provided to the igniter (3.1.1, 3.2.1) or to an intermediate control device (2) and in which the igniter (3.1.1, 3.2.1) is fired, characterized in that the transmission of the disposal firing orders to the igniter (3.1.1, 3.2.1) or to the intermediate control device (2) is effected each on at least two different, separated and independent interfaces (6.1, 6.2, 4.1, 4.2, 4.3) and that decoding of the disposal firing order initiated from outside is effected in the control device (2) by means of at least two different, separated and independent units for signal decoding (7.1, 7.2) and that the forwarding is effected to at least two different, separated and independent signal paths (4.1, 4.2, 4.1.1, 4.2.1, 4.2.2, 4.1.2).

The invention is based on the idea to have an activation of the disposal effected by means of disposal orders which are supplied from outside, contrary to an activation order in the case of a crash which is subject to acceleration or over-rolling, for obtaining the above-mentioned safety in relation to simple errors the disposal firing order being effected or transmitted to the igniter/s or to an intermediate control device such that the transmission of the disposal firing order and the transmission of the disposal firing order which is initiated from outside is effected on at least two separated/different interfaces.

In the following example of embodiment according to the invention no further, detailed reference is made to the individual functional principles of the already mentioned basic solutions, as the respective functional principle or the contents of the respective scripts, can be regarded as being included in its entirety by the cross reference and can be considered as the state of art, respectively.

To simplify matters in the following partly only individual terms are used, whereas it is to be kept in mind that in this connection also the accompanying components necessary for a system are to be understood or incorporated/included, as the case may be.

In the description and in the associated drawings those terms and associated reference numerals are used, which are used in the list added below.

In the following the invention is to be further described on the basis of an example of embodiment with the aid of FIGS. 1 to 6. It must be noted that for simplifying matters mostly only the umbrella term of a system cited as a representative is used in the figure description. It goes without saying that these include also other systems with a comparable functional principle or devices with analogous functions.

### BRIEF DESCRIPTION OF THE DRAWINGS

It is shown in

FIG. 1 a principal possible realization for disposal of active protection devices of an occupant protection system with pyrotechnic igniters according to the invention;

FIG. 2 a principal possible realization for disposal of the active protection devices of an occupant protection system with pyrotechnic igniters according to the invention, supplemented with details;

FIG. 3 a detailed representation of a control device for disposal of the active protection devices of an occupant protection system with pyrotechnic igniters according to the invention;

FIG. 4 a detailed representation of a control device for disposal of the active protection devices of an occupant protection system with pyrotechnic igniters according to the invention;

FIG. 5 a principal possible realization for disposal of the active protection devices of an occupant protection system with pyrotechnic igniters according to the invention, shown as a BUS-realization;

FIG. 6 a chronological representation of the transmission of the disposal firing order.

### DETAILED DESCRIPTION OF THE DRAWINGS

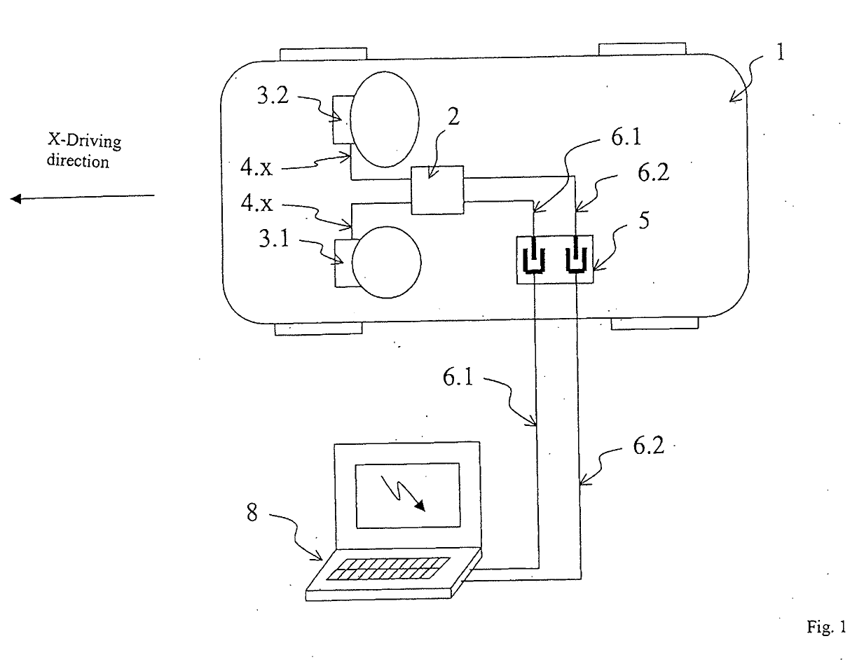

FIG. 1 shows a principal possible realisation for disposal of the active protection devices of an occupant protection system with pyrotechnic igniters according to the invention. Depending on the type of the occupant protection system in the vehicle (1), it consists in the simplest version of a control device (2) and the associated airbags, such as for example the driver airbag (3.1), consisting of a pyrotechnic igniter, a gas generator and an airbag, and the co-driver airbag (3.2), in turn consisting of a pyrotechnic igniter, a gas generator and an airbag. The control device includes the electrical power switches (not shown in detail in this drawing) and the interface lines (4.x) provided for this purpose, which in the case of a crash are necessary to transmit an activation order, which is subject to acceleration or over-rolling, to the pyrotechnic igniter.

The control device (2) has at least two separated/different interfaces (6.1, 6.2), which are supplied to the diagnostic connector (5)/to the diagnostic adapter (5) of the vehicle to ensure a diagnosis of the control device (2) from outside in the case of a service or in the garage operation by at least one interface to the control device (2), to verify for example the error storage of the control device.

Analogue to the garage service tester the diagnostic connector (5)/at the diagnostic adapter (5) of the vehicle, as is shown in FIG. 1, the device (8) can be connected for producing a disposal firing order/disposal order, the disposal order having to be effected for safety reasons according to the invention, as above described, via at least two separated/different interfaces (6.1, 6.2).

In the simplest case the first interface (6.1) is for example a so-called CAN-bus and the second interface (6.2) is a further CAN-bus or a communication line, such as e.g. a PAS-interface, a K-line, a VAN-interface, a modulated energy supply line (clamp 15) or the like, already existing in the vehicle (1) and at the control device (2), respectively. Depending on the type of the respective interface this may be a one-wire, two-wire or multi-wire interface.

A further advantage, which results in addition to the desired realisation of a stable/malfunction-free disposal firing possibility, is that with the use of interfaces (6.1, 6.2) already existing in the vehicle (1) and at the control device (2), respectively, no further/additional costs are required for the placement of interfaces (lines, plug pins & interfaces) necessary for this purpose.

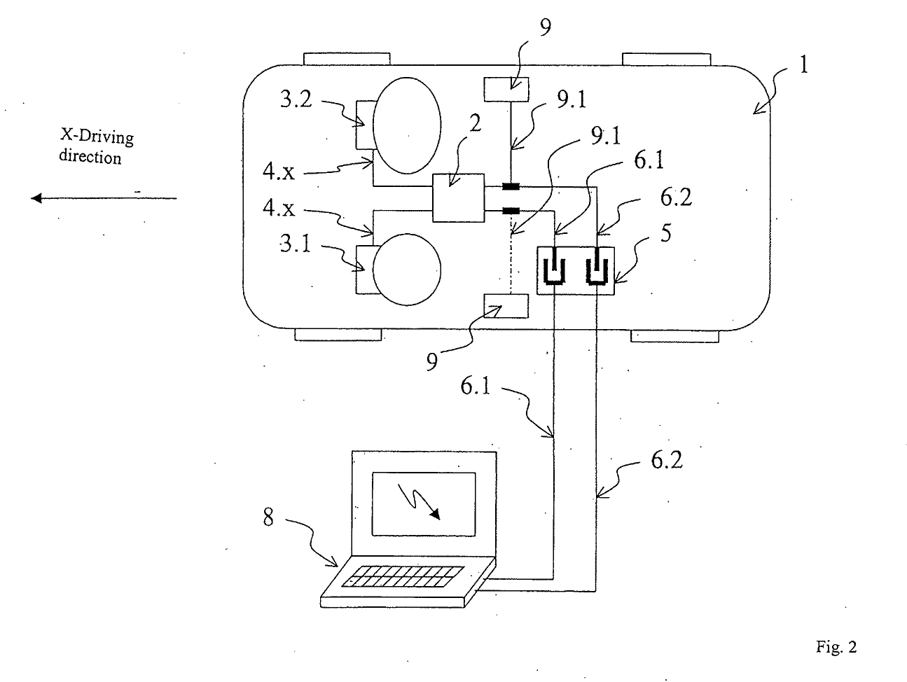

FIG. 2 shows a principal possible realisation for disposal of the active protection devices of an occupant protection system with pyrotechnic igniters according to the invention, supplemented with details.

The occupant protection system in the vehicle (1) is shown analogously to FIG. 1, and is supplemented with two so-called sourced-out assistant sensors (9), which are each connected to the centrally arranged control device (2) by means of an interface (9.1) to enable the assistant sensors to transmit their crash relevant information to the control device (2).

The so-called out-sourced assistant sensors (9), which are attached as close as possible to the vehicle body shell, are sensors for monitoring and detecting the forces and accelerations, respectively, acting onto the vehicle (1) to ensure in the case of a crash relatively fast activation times for the road user protection system/occupant protection system.

As can be further seen from FIG. 2, in this case for example the interface (9.1) to the one assistant sensor (9) is combined with the interface (6.2) (what is, however, not mandatory), since a communication request as a rule is required/effected only from a connected communication-capable unit (8, 9), as the two purposes (crash activation request & disposal firing request) more or less exclude each other. As is further implied in the figure, also the other interface (9.1) to the other assistant sensor (9) can be combined with the interface (6.1) (however, not mandatory), as far as the two communication-capable units (8, 9) have the same physical interface.

For effecting the desired disposal firing, at two separated/different interfaces (6.1, 6.2) one disposal activation request/disposal firing order each is applied/arranged simultaneously or concurrent in time, so that at least for a certain defined time concurrently closing of the power switch/es LOW/of the interface/s L (4.1) and of the power switch/es HIGH/of the interface/s H (4.2) is effected. As far as, as shown in the figure, several pyrotechnic igniters or more than one occupant protection device are to be disposed of, it has proven to make sense that the protocol for activating the disposal firing is to be interpreted such that each individual pyrotechnic igniter can be activated individually/separately so that for example the pressure development in the vehicle (1) generated during the disposal firing can be kept defined to a certain degree.

The protocol or the protocol contents of the corresponding interface (6.1, 6.2), which is to be used for effecting the disposal firing, in particular in case for example the interface (9.1) is combined with the interface (6.2), is to be preferably chosen in such manner that an order, which is supposed to initiate a disposal firing, is defined on the interface (6.2) in such manner as it is not provided for in the defined protocol scale of the assistant sensor (9) and on its interface (9.1), respectively. However, as an alternative, the protocol or the protocol contents of the corresponding interface (6.1, 6.2) can also be deliberately chosen, in particular if the protocol depth is relatively restricted, in such manner that an order, which is supposed to initiate a disposal firing, is defined on the interface (6.2) in such manner as it corresponds to an activation request information of the assistant sensor (9) in the defined protocol scale of the assistant sensor (9) and on its interface (9.1), respectively. The latter is especially relevant if the unit for signal decoding (7.2) and the unit for level conversion (7.2), respectively, which preferably is realised as an ASIC or as a monitoring unit in an ASIC, or as a μP, has activation-capable algorithms.

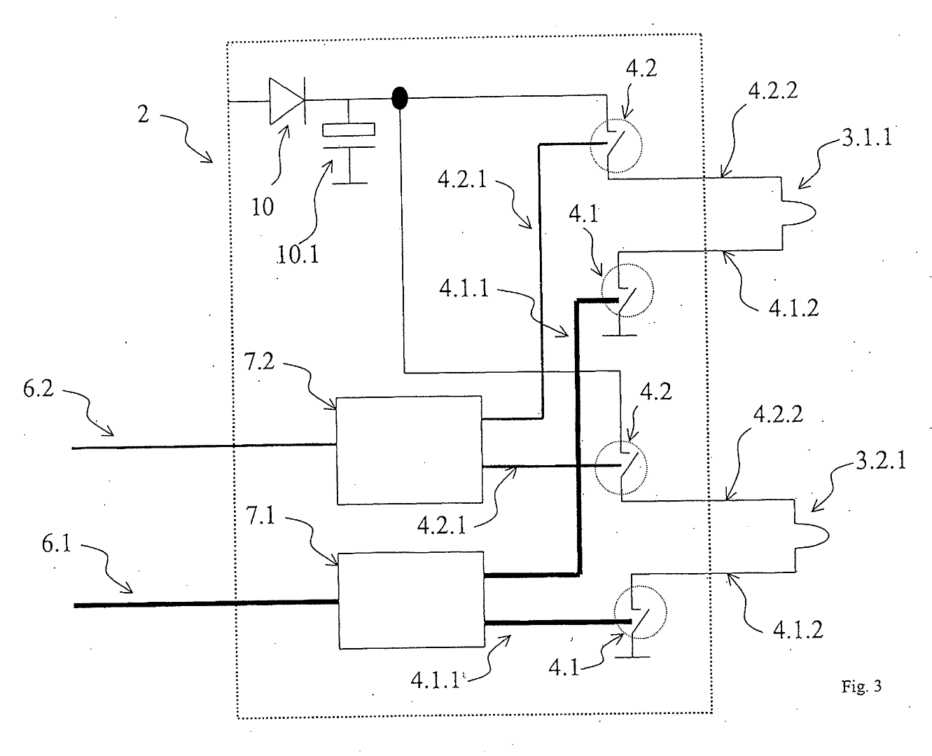

FIG. 3 shows a detailed representation of a control device (2) for disposal of the active protection devices of a road user protection system/occupant protection system with pyrotechnic igniters according to the invention.

The in accordance with the invention at least two separated/different interfaces (6.1, 6.2) of the control device (2) are supplied here to two separated/different units (7.1, 7.2) which are independent to each other. The first unit (7.1), which in this case for application reasons is for example the algorithm, implemented for evaluating the crash-relevant signal courses, which are subject to acceleration or over-rolling, of the forces and accelerations, respectively acting onto the vehicle (1), serves as a unit for signal decoding (7.1) and as a unit for level conversion (7.1), respectively, and is preferably realised as an ASIC or as a monitoring unit in an ASIC or as a μP.

The outputs of the at least two separated/different units (7.1, 7.2), which are independent to each other, are each connected by means of the connecting appropriate control lines (4.1.1, 4.2.1) to the current-capable power switches HIHG/interfaces H (4.2) and current-capable power switches LOW/interfaces L (4.1) necessary for the disposal firing in the firing circuit. The outputs (4.2.2) of the current-capable power switches HIHG/interfaces H (4.2) are connected to the pyrotechnic igniters (3.1.1, 3.2.1) for the driver airbag (3.1) and the co-driver airbag (3.2), which with their second connection are each connected to the input (4.1.2) of the current-capable power switches LOW/interfaces L (4.1).

As soon as the at least two separated/different units (7.1, 7.2), which are independent to each other, receive a disposal activation order via the interfaces (6.1, 6.2), they initiate a closing of the current-capable power switches HIHG/interfaces H (4.2) and current-capable power switches LOW/interfaces L (4.1), so that current can flow from the energy storage (10.1), which is charged by the power supply (10) not shown in detail of the control device (2), via the pyrotechnic igniters (3.1.1, 3.2.1), which current flow finally results in the desired activation of the pyrotechnic igniters (3.1.1, 3.2.1) or for disposal firing of the pyrotechnic igniters (3.1.1, 3.2.1) plus the protection devices connected thereto, such as driver airbag (3.1) and co-driver airbag (3.2).

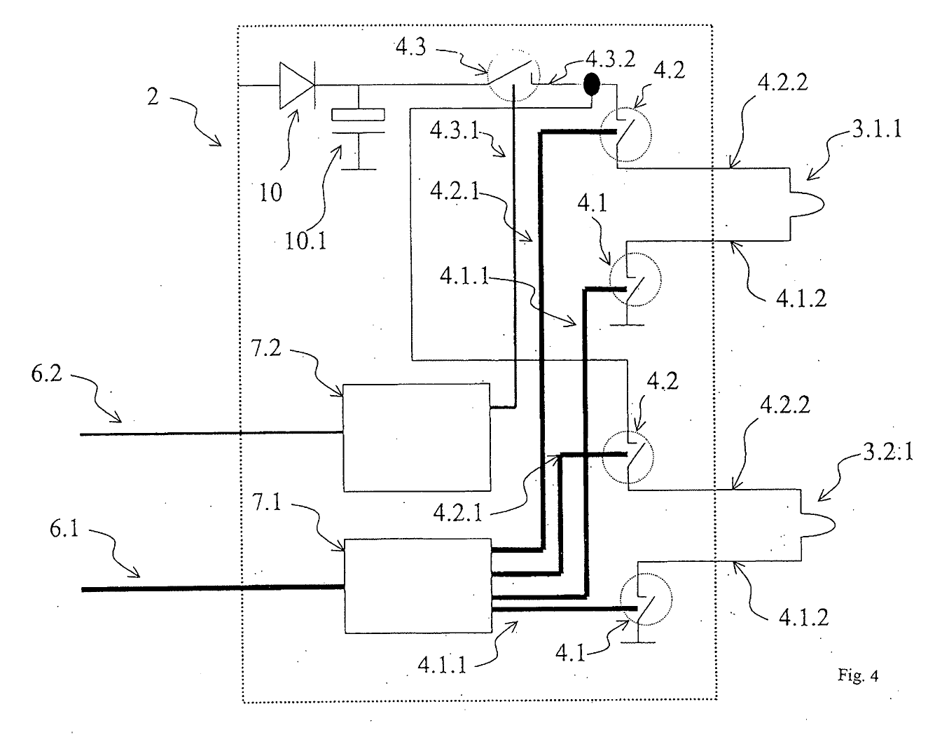

FIG. 4 shows a detailed representation of the control device (2) for disposal of the active protection devices of a road user protection system/occupant protection system with pyrotechnic igniters according to the invention.

The in accordance with the invention at least two separated/different interfaces (6.1, 6.2) of the control device (2) are supplied here analogue to FIG. 3 to two separated/different units (7.1, 7.2) which are independent to each other. In addition, in contrast to FIG. 3, in this example of embodiment a third power switch/an interface 3 (4.3) is located between the energy storage (10.1) of the control device (2) and the current-capable power switches HIHG/interfaces H (4.2).

Other than in FIG. 3, in FIG. 4 triggering of the current-capable power switches HIHG/interfaces H (4.2) and current-capable power switches LOW/interfaces L (4.1) is effected by means of the connecting appropriate control lines (4.1.1, 4.2.1) through the unit 1 for signal decoding (7.1). Triggering of the third power switch/interface 3 (4.3) is effected in this example by means of the connecting appropriate control lines (4.3.1) through the unit 2 for signal decoding (7.2). Thus, it is ensured also in this example of FIG. 4 (analogue to FIG. 3) that a disposal firing is effected each via two separated/independent/different signal paths as also via at least two separated/independent/different circuit parts, so that the desired stableness/interference resistance against an unintended disposal firing can be ensured also in case of the occurrence or existence of a simple error.

As a further possibility to obtain the desired stableness/interference resistance against an unintended disposal firing, the realization not shown in detail is to be taken into consideration, in which the firing energy required for disposal is supplied especially destined for disposal firing by means of a first interface (supply line) (6.1, 6.2) statically or dynamically (instead of the energy storage (10.1) of the control device (2)) from outside, and in which by means of a further interface (6.1, 6.2) and a unit 1 or a unit 2 for signal decoding (7.1, 7.2) the vital order for disposal firing is transmitted.

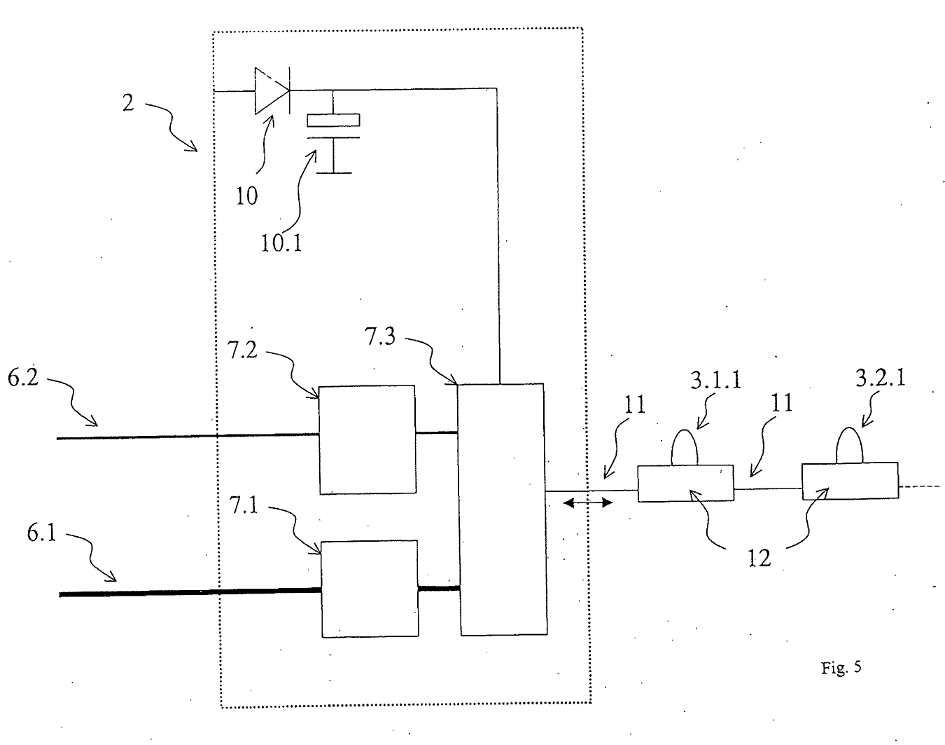

FIG. 5 shows a principally possible realization for disposal of the active protection devices of an occupant protection system with pyrotechnic igniters according to the invention, shown as a BUS-realization/“firing-BUS-airbag-realization”.

Other than in FIG. 3, the power switches HIHG/interfaces H (4.2) and power switches LOW/interfaces L (4.1) required for disposal firing of the pyrotechnic igniters (3.1.1, 3.2.1) are not located in the control device (2), but in the so-called IPEs (Integrated Peripheral Electronic Units) (12), which are connected by a BUS-connection (11) in the vehicle to the control device (2) and to the BUS-interface-driver-unit (7.3) provided for this purpose in the control device (2).

The BUS-interface-driver-unit (7.3) is connected on the input side to the two outputs of the two separated/different units (7.1, 7.2), which are independent to each other, to receive the corresponding control orders, such as for example the disposal firing control order by the two separated/different units (7.1, 7.2), which are independent to each other, and to lead/transmit them by means of the BUS-connection (11) in the vehicle to the so-called IPEs (Integrated Peripheral Electronic Units) (12), or to the pyrotechnic igniter (3.1.1, 3.2.1) which is connected thereto, in order to initiate there a disposal firing.

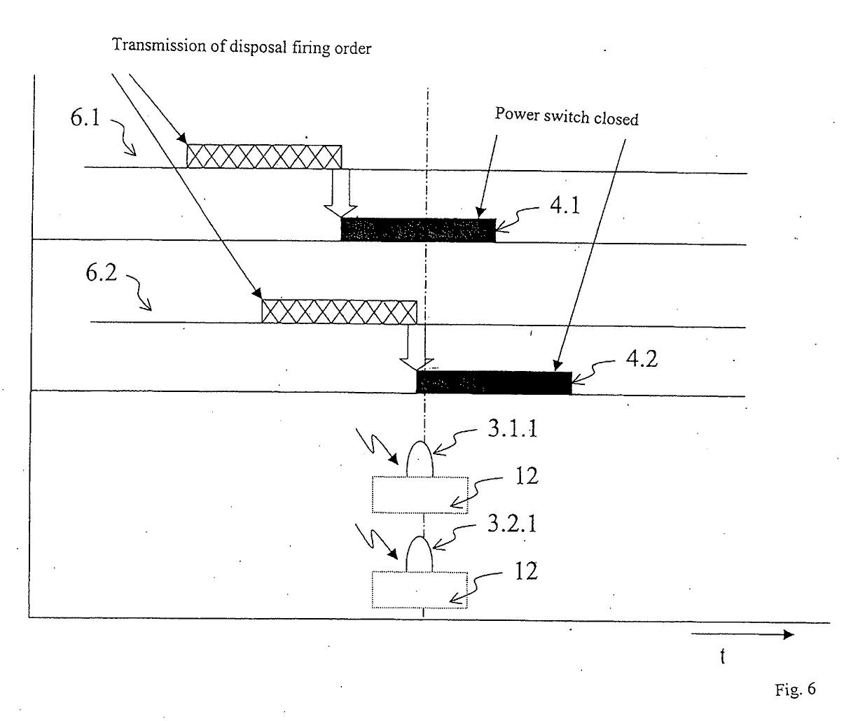

FIG. 6 shows a chronological representation of the transmission/realization/implementation of the disposal firing order.

At the first interface (6.1), as is shown, a disposal firing order is applied from externally/outside, which according to FIG. 3 in the control device results in/effects closing for a defined time of the power switch/es LOW/of the interface/s L (4.1). If at the second interface (6.2) simultaneously or with a certain concurrence in time a disposal firing order is also applied from externally/outside, which again in the control device for a defined time results in/effects closing of the power switch/es HIGH/of the interface/s H (4.2), this leads to the desired disposal firing of the road user protection devices, which for reasons of clearness alternatively are shown in FIG. 6 only as pyrotechnic igniters (3.1.1, 3.2.1) for the driver airbag (3.1) and for the co-driver airbag (3.2). The power switches HIHG/interfaces H (4.2) and power switches LOW/interfaces L (4.1) required here for disposal firing of the pyrotechnic igniters (3.1.1, 3.2.1) can be located, as implied by the dashed lines, either in the IPEs (Integrated Peripheral Electronic Units) (12), as far as this is a so-called “firing-BUS-airbag-realization”, as is shown in FIG. 5, or in the control device (2), as far as this is for example a so-called conventional/standard “central-airbag-realization”, as it is shown in FIG. 3.

### LIST OF REFERENCE NUMERALS

1 Vehicle
2 Control device
3.1 Driver airbag (incl. gas generator with pyrotechnic igniter)
3.1.1 Pyrotechnic igniter for driver airbag
3.2 Co-driver airbag (incl. gas generator with pyrotechnic igniter)
3.2.1 Pyrotechnic igniter for co-driver airbag
4.1 Interface L (e.g. power switch LOW)
4.1.1 Trigger for interface L
4.1.2 Current path from interface L (e.g. input power switch LOW)
4.2 Interface H (e.g. power switch HIGH)
4.2.1 Trigger for interface H
4.2.2 Current path from interface H (e.g. output power switch HIGH)
4.3 Interface 3 (e.g. third power switch)
4.3.1 Trigger for interface 3
4.3.2 Current path from interface 3 (e.g. output third power switch)
5 Diagnostic connector/diagnostic adapter (for vehicle diagnostics)
6.1 Interface 1 (e.g. CAN-bus)
6.2 Interface 2 (e.g. PAS-interface)
7.1 Unit 1 for signal decoding/level conversion (e.g. logical arithmetic unit/μP)
7.2 Unit 2 for signal decoding/level conversion (e.g. logical unit/ASIC)
7.3 BUS-interface driver unit
8 Device for producing a disposal order
9 Assistant sensor
9.1 Interface to assistant (e.g. PAS-interface—peripheral-assistant-interface)
10 Power supply
10.1 Energy storage
11 Internal BUS-connection (e.g. special vehicle bus)
12 IPE (e.g. Integrated Peripheral Electronic Unit—electr. with power sw. H & L)

1-13. (canceled)

14. A method for disposing of road user protection devices with at least one pyrotechnic igniter, the method comprising:
providing a disposal firing order to an igniter (3.1.1, 3.2.1) or to an intermediate control device (2) and in which the igniter (3.1.1, 3.2.1) is fired, wherein the transmission of the disposal firing orders to the igniter (3.1.1, 3.2.1) or to the intermediate control device (2) is effected each on at least two different, separated and independent interfaces (6.1, 6.2, 4.1, 4.2, 4.3); and
decoding of the disposal firing order initiated from outside is effected in the control device (2) by f at least two different, separated and independent units for signal decoding (7.1, 7.2) and that the forwarding is effected to at least two different, separated and independent signal paths (4.1, 4.2, 4.1.1, 4.2.1, 4.2.2, 4.1.2).

15. A method according to claim 14, wherein a concurrence in time of the disposal firing orders at the at least two separated one-wire, two-wire or multi-wire interfaces (6.1, 6.2) and an overlapping in time of the interfaces (4.1, 4.2) is necessary for a certain defined time to result in a simultaneous closing of the power switch LOW of the interfaces (4.1) and of the power switch HIGH of the interfaces H (4.2).

16. A method according to claim 14, wherein for effecting the disposal firing at least one interface (6.1, 6.2) is used to which also an assistant sensor (9) transmits (9.1) data and the protocol is chosen such that an order, which is supposed to initiate a disposal firing, is defined on the interface (6.2) in such manner as it is not provided for in the defined protocol scale of the assistant sensor (9).

17. A method according to claim 14, wherein for effecting the disposal firing at least one interface (6.1, 6.2) is used to which also an assistant sensor (9) transmits (9.1) data and that the protocol is chosen such that an order, which is supposed to initiate a disposal firing, is defined on the interface (6.2) in such manner as it corresponds in the defined protocol scale of the assistant sensor (9) or on its interface (9.1) to an activation request information of the assistant sensor (9).

18. A method according to claim 14, wherein the method is for disposal of occupant restraint systems such as belt tensioners, airbags, pedestrian protection systems or over-roll systems

19. A device for effecting a for disposal of road user protection devices with at least one pyrotechnic igniter, in which a disposal firing order can be provided to the igniter (3.1.1, 3.2.1) or to an intermediate control device (2) and in which the igniter (3.1.1, 3.2.1) can be fired, the device comprising:
at least two different, separated and independent interfaces (6.1, 6.2, 4.1, 4.2, 4.3) are provided for transmitting the disposal firing orders to an igniter (3.1.1, 3.2.1) or to an intermediate control device (2); and
in the control device (2) at least two different, separated and independent units for signal decoding (7.1, 7.2) are provided for decoding the disposal firing order initiated from outside and that at least two different, separated and independent signal paths (4.1, 4.2, 4.1.1, 4.2.1, 4.2.2, 4.1.2) are provided for forwarding.

20. A device according to claim 19, wherein at least one of the interfaces (6.1, 6.2) is a CAN-bus-interface.

21. A device according to claim 19, wherein at least one of the interfaces (6.1, 6.2) is a VAN-bus-interface.

22. A device according to claim 19, wherein at least one of the interfaces (6.1, 6.2) is a PAS-interface.

23. A device according to claim 19, wherein at least one of the interfaces (6.1, 6.2) is a K-interface.

24. A device according to claim 19, wherein at least one of the interfaces (6.1, 6.2) is an energy supply line with an up-modulated information.

25. A device according to claim 19, wherein the unit for signal decoding (7.1) and the unit for level conversion (7.2), respectively, are realized as an ASIC or as a monitoring unit in an ASIC, or as a microprocessor.

26. A device according to claim 19, wherein the units for signal decoding (7.1, 7.2) and the units for level conversion (7.2), respectively, have activation-capable algorithms.
